(19) United States
(12) Patent Application Publication
(10) Pub. No.: US 2002/0121719 A1
(43) Pub. Date: Sep. 5, 2002

(54) Method and apparatus for subsurface venting or injecting in liquid molding

(76) Inventor: Richard L. Petrovich, Brunswick, OH (US)

Correspondence Address: Daniel A. Thomson, Esq., Fourteenth Floor, One Cascade Plaza, Akron, OH, 44308-1147, US

(21) Appl. No.: 10/085,277

(22) Filed: Feb. 27, 2002

Related U.S. Application Data
(60) Provisional application No. 60/271,835, filed on Feb. 27, 2001.

(51) Int. Cl. B29C 70/70

(52) U.S. Cl. 264/102; 264/257; 425/129.1; 425/812

(57) ABSTRACT

A new and improved method and apparatus for liquid resin molding, using subsurface venting is described herein. The inserts can be placed virtually any where in the mold, and vacuum or injection can be introduced to suit the part geometry. The process is to draw the resin through the mold, thereby creating a uniform wetting effect of the fabric by the resin.

This application claims priority to a provisional patent application, U.S. Ser. No. 60/271,835, entitled METHOD AND APPARATUS FOR SUBSURFACE VENTING IN COMPOSITE RESIN MOLDING, filed Feb. 27, 2001. This invention relates to the art of liquid molding, and more particularly to the art of resin transfer molding.

### I. BACKGROUND OF THE INVENTION

A. Field of the Invention

B. Description of the Related Art

Currently, in order to make large parts using composite resin molding, where the fabric is infiltrated with resin in the mold, a high pressure must be used to push the resin through the fabric in the mold. The high injection pressure is required because the high fraction volume of the fabric in the part and the high viscosity of the resin make it difficult to move resin through the fabric before it starts to cure. Therefore, since high pressures need to be used, and the resin has difficulty traveling great distances without creating defects by moving the fabric or leaving dry spots, up to this point, it has been almost impossible to make very large parts using composite resin molding.

Two of the main problems using large or complex components utilizing a liquid infusion method is the ability to first wet-out the entire part and second, to do so without moving the fabric.

Current technology relies on an uncontrolled flooding technique, typically using edge-of-part venting and injection. This uncontrolled technique leaves areas of fabric dry, and often moves fabric when pressures are increased in an attempt to overcome the dry spots. This method creates still another problem. With increased pressures in the mold, the mold deflection issues are exaggerated. Overcoming this problem may require more mold material, or worse yet, large presses to overcome the deflection.

This approach, using elevated pressure, has caused part manufacturers to establish a higher than necessary standard for injection pressure, and to limit the size or complexity of composite parts under consideration for the liquid molding process.

The present invention provides a new and improved apparatus and method for composite resin molding using subsurface venting and injection, and overcomes certain difficulties inherent in the related inventions while providing better overall results.

### II. SUMMARY OF THE INVENTION

In accordance with one aspect of the present invention, a method of liquid molding includes the steps of providing a mold having a face and top portion, first and second sides, and first and second ends, the mold having injection ports on both sides and ends, providing multiple independently fed subsurface inserts, applying plies to the mold, attaching fabric end caps onto aluminum mandrels, sliding braided sleeves over the mandrels, positioning the mandrels over the bottom portion, placing braided material along mandrel radius interfaces, placing the top portion to the bottom portion, attaching root, tip, and slide closure plates to the mold, inserting the mold into a restraining fixture, inserting metal wedges into the fixture, attaching a steel box to the mold and the fixture, connecting resin injection and vacuum lines to the mold, injecting degassed resin through heated tubing, and activating the inserts.

In accordance with another aspect of the present invention, a method for liquid molding includes the steps of providing an associated mold, providing at least one independently fed subsurface insert, wetting fabric through the mold, and activating the at least one insert, manually controlling the venting, controlling the venting via a computerized injection and venting process.

In accordance with yet another aspect of the present invention, a composite resin mold includes a body, at least one injection port, at least one resin track, and at least one independently fed subsurface insert.

In accordance with still another aspect of the present invention, the mold has multiple injection ports and multiple channels.

In accordance with another aspect of the present invention, the mold includes a top portion, a face, the inserts being located on the face and top portions, first, second, third, and fourth side portions, a vent, vent openings, the vent openings being of a size to restrict entry of associated fabric, and the at least one injection port is independently fed.

In accordance with yet another aspect of the present invention, the mold includes an adapter plate, a retaining bolt, an o-ring, a vent pocket for receiving the insert, the insert contoured to fit the face of the mold, the resin track being located circumferentially around the venting insert, and a vent.

In accordance with another aspect of the present invention, the vent extends upwardly from the resin track.

In accordance with still another aspect of the present invention, a venting insert for use with liquid infusion molds includes an independently fed vent, a resin track, the resin track located substantially circumferentially around the insert, and suction means for creating suction.

In accordance with another aspect of the present invention, the insert further includes an injection port opening.

In accordance with another aspect of the present invention, the vent is connected to the resin track and the vent extends upwardly from the resin track.

In accordance with yet another aspect of the present invention, the insert further includes o-rings for connecting the insert to an associated mold.

In accordance with another aspect of the present invention, the mold includes at least one vent pocket and multiple vent pockets, the vent pockets being inset in the surface of the mold.

### III. BRIEF DESCRIPTION OF DRAWINGS

The invention is illustrated in the following drawings:

FIG. 1 is a perspective view of the mold, showing thirteen vent pockets;

FIG. 2 is a top view of the insert, showing the interrupted vents around the perimeter;

FIG. 3 is a sectional view of the mold along line A-A of FIG. 2;

FIG. 4 is a sectional view of the mold along line B-B of FIG. 2; and,

FIG. 5 is a sectional view of the mold along line B-B of FIG. 2, showing the hose connected to the injection/vent port.

### IV. DESCRIPTION OF SEVERAL EMBODIMENTS

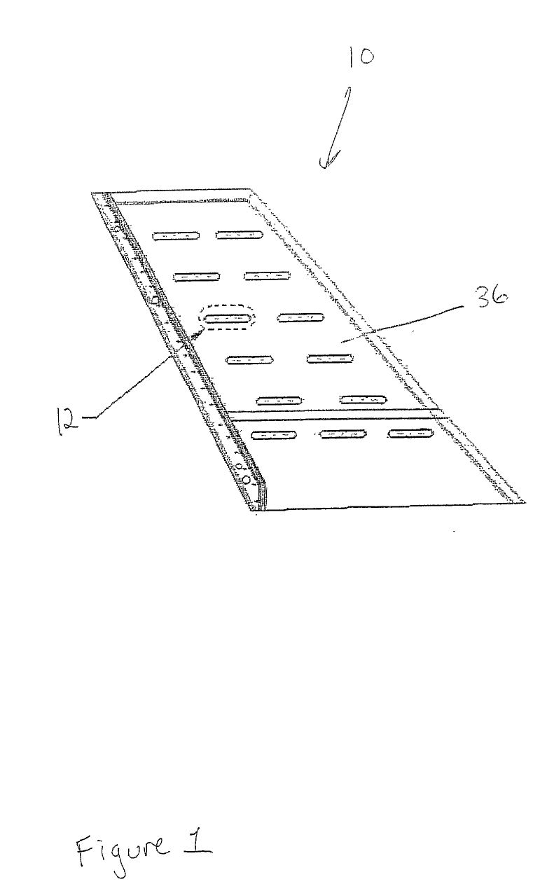

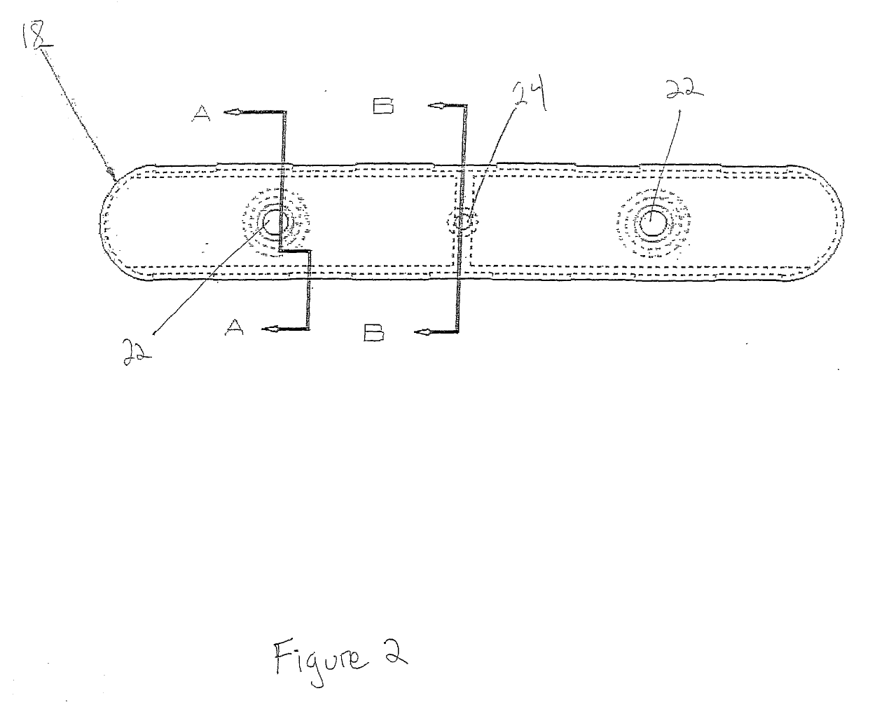

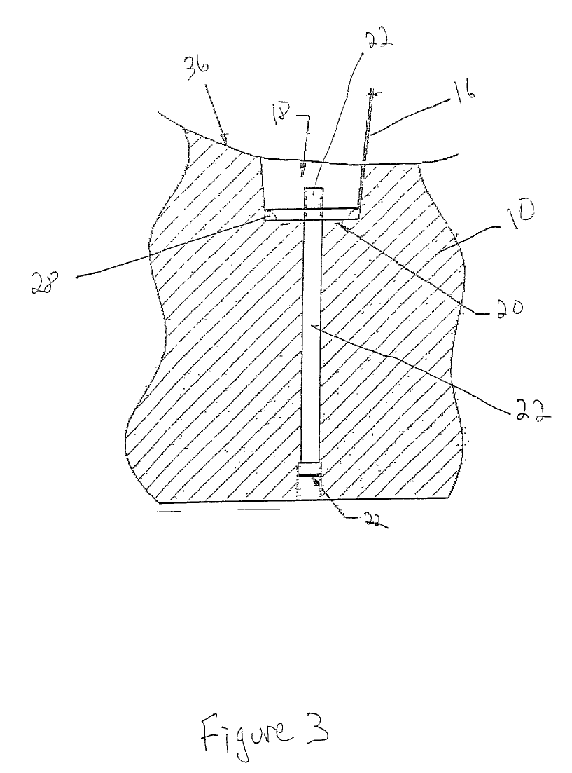

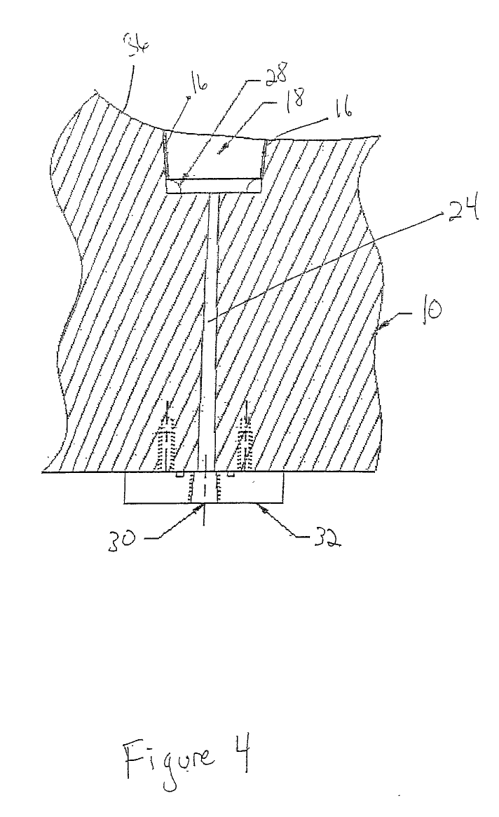

With reference to FIGS. 1-5, the inventive mold 10 and inserts 18 are shown. FIG. 1 shows the general view of the mold 10 and the vent pockets 12, an exploded view of which is shown in FIG. 2. FIGS. 3, 4, and 5 are cross-sectional views of lines A-A and B-B in FIG. 2. Section A-A is through retaining bolt 22, which holds the insert 18 in place and Section B-B is through injection port 30, which is used for venting or injection, along with the adapter plate 32 for tubing.

With reference now to FIG. 3-5, the FIGURES show the mold 10, vent track 16, vent insert 18, o-ring 20, retaining bolt 22, injection or vent line 24, resin or vent track 28, injection port 30, adapter plate 32, and hose 34. The resin flows through the hose 34, attached to the adapter plate 32, through the injection or vent line 24 into the resin or vent track 28.

With continued reference to FIGS. 3-5, the vent insert 18 is located in the vent pocket 12, which is a flat-bottomed pocket in the face 36 of the mold 10. The face 36 of the mold 10 can be contoured to match the mold 10. The mold 10, as shown in FIG. 1, has a face 3 6, a top portion (not shown), first, second, third, and fourth sides (shown but not referenced). In this embodiment, the inserts 18 are located on the top and/or bottom parts of the mold 10. The injection or vent port 24 is located within the mold 10, and connects the injection port 30 and the vent or injection insert 18. The injection port 30 is an integral part of the adapter plate 32, which is held in place by bolts (shown but not referenced). The hose 34 is connected to the adapter plat 32, so that the resin can be injected into the mold 10, drawn into the injection line 24, and into the mold 10 via vent 16.

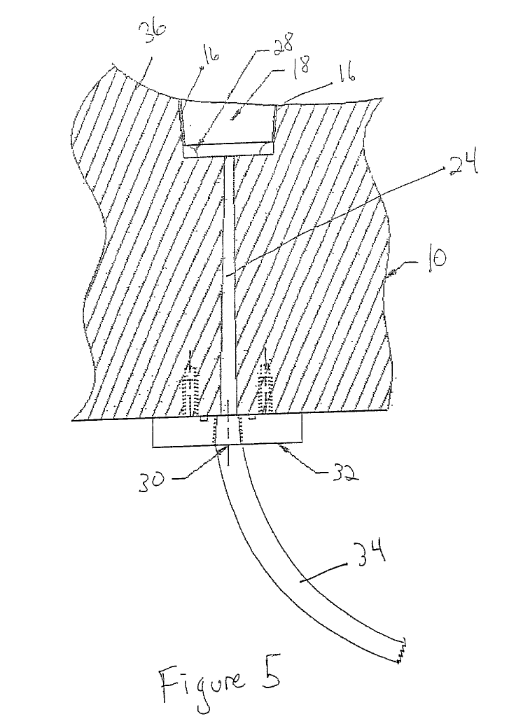

The insert 18, as shown in FIG. 5, has resin tracks 28, which in this embodiment, are circumferential around the insert 18. The resin travels through the injection port 30 into the injection line 24 and into the resin track 28. The resin is drawn through the injection line 24 by vacuum pressure applied from the vent 16. The insert 18 can be used for either vacuum or injection, but not both simultaneously. The vent 16 allows the resin to be injected in strategic locations in the mold 10 for resin to be drawn through the fabric by use of a vacuum. The insert 18 is, in this embodiment, held to the mold 10 by bolts 22 and sealed by o-rings 20. It is to be understood, however, that any means of connecting the insert 18 to the mold 10 can be used as long as chosen using sound engineering judgment. The adapter plate 32 connects the hose 34, for venting or injecting, to the injection line 24, and is bolted to the mold 10 by bolts (shown but not referenced). Again, this is merely one embodiment of the invention and is not intended to limit it in any manner.

In this embodiment, each of the inserts 18 and injection ports 30 is independently fed. By “independently fed” it is meant that the vacuum or injection pressure for each insert 18 can be controlled independently of the other inserts 18. Therefore, the pressure can be altered for individual inserts 18, so that the resin can be drawn through at different speeds. Also, each vent or injection port 30 can be turned on or off, as necessary.

The inventive process works by positioning the inserts 18 into the mold 10 so that the air trapped in the mold 10 or the resin can be evacuated and the resin can be infused in strategic locations under controlled sequences.

In another embodiment of this invention, the inserts 18 and injections ports 30 can be used in conjunction with a computerized injection and venting process, allowing for precision sequencing and processing control.

Although this particular embodiment has been described using the resin transfer or composite resin molding, it is to be understood that the inventive process can be used with, but is not limited to, the following process: vacuum assisted resin transfer molding, resin injection recirculation molding, vacuum assisted resin injection, Seeman's composite resin infusion resin molding process, vacuum infusion process, and virtually any liquid molding process.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. A method of liquid molding, the method comprising the steps of:
providing a mold having a face, a top portion, first and second sides, and first and second ends, the mold having injection ports on both sides and ends;
providing multiple independently fed subsurface inserts;
applying plies to the mold;
attaching fabric end caps onto aluminum mandrels;
sliding braided sleeves over the mandrels;
positioning the mandrels over the bottom portion;
placing braided material along mandrel radius interfaces;
placing the face to the top portion;
attaching root, tip, and slide closure plates to the mold;
inserting the mold into a restraining fixture;
inserting metal wedges into the fixture;
attaching a steel box to the mold and the fixture;
connecting resin injection and vacuum lines to the mold;
injecting degassed resin through heated tubing; and,
activating the inserts.

2. A method for liquid molding, the method comprising the steps of:
providing an associated mold;
providing at least one independently fed subsurface insert;
wetting fabric through the mold; and,
activating the at least one insert.

3. The method of claim 2, wherein the method further comprises the step of:
manually controlling the venting.

4. The method of claim 2, wherein the method further comprises the step of:
controlling the venting via a computerized injection and venting process.

5. A composite resin mold, the mold comprising:
a body;
at least one injection port;
at least one resin track; and,
at least one independently fed subsurface insert.

6. The mold of claim 5, wherein the mold has multiple injection ports and multiple channels.

7. The mold of claim 5, wherein the at least one independently fed subsurface insert is multiple inserts, the mold further comprising:
a top portion;
a face, the inserts being located in vent pockets;
at least one vent;
first, second, third, and fourth side portions; and,
vent openings, the vent openings being of a size to restrict entry of associated fabric.

8. The mold of claim 7, wherein the at least one injection port is independently fed.

9. The mold of claim 8, wherein the mold further comprises:
an adapter plate;
a retaining bolt; and,
an o-ring.

10. The mold of claim 9, wherein the mold further comprises:
a vent pocket for receiving the insert, the insert contoured to fit the mold face.

11. The mold of claim 5, wherein the mold further comprises the resin track being located circumferentially around the venting insert.

12. The mold of claim 11, wherein the vent extends upwardly from the resin track.

13. A venting insert for use with liquid infusion molds, the insert comprising:
an independently fed vent;
a resin track, the resin track located substantially circumferentially around the vent; and,
suction means for creating suction.

14. The insert of claim 13, wherein the insert further comprises:
an injection port opening.

15. The insert of claim 14, wherein the vent is connected to the resin track and the vent extends upwardly from the resin track.

16. The insert of claim 15, wherein the insert further comprises:
o-rings for connecting the insert to an associated mold.

17. The mold of claim 5, wherein the mold further comprises:
at least one vent pocket.

18. The mold of claim 17, wherein the mold further comprises multiple vent pockets, the vent pockets being inset in the surface of the mold.

19. The method of claim 2, wherein the method further comprises the steps of:
alternating at least the one independently fed subsurface insert; and,
alternating operation of an injection port.
